(19) United States
(12) Patent Application Publication
(10) Pub. No.: US 2009/0153412 A1
(43) Pub. Date: Jun. 18, 2009

(54) ANTENNA SLOT WINDOWS FOR ELECTRONIC DEVICE

(76) Inventors: Bing Chiang, Cupertino, CA (US); Gregory Allen Springer, Sunnyvale, CA (US); Douglas B. Kough, San Jose, CA (US); Enrique Ayala, Watsonville, CA (US); Matthew Ian McDonald, San Jose, CA (US)

Correspondence Address: G. VICTOR TREYZ, 870 MARKET STREET, FLOOD BUILDING, SUITE 984, SAN FRANCISCO, CA, 94102, US

(21) Appl. No.: 11/959,306

(22) Filed: Dec. 18, 2007

(51) Int. Cl. H01Q 1/42; H01Q 1/24

(52) U.S. Cl. 343/702; 343/872

(57) ABSTRACT

Antenna window structures and antennas for electronic devices such as portable electronic devices are provided. The electronic devices may be computers or other devices that have conductive housings. Antenna windows may be formed from one or more slots in the conductive housings. The slots may be filled with air or a solid dielectric such as epoxy. There may be a number of parallel slots in a given antenna window, each having a width that is sufficiently narrow to make the antenna window invisible or unnoticeable to the naked eye under normal observation. An antenna may be formed within an electronic device adjacent to an antenna window. The antenna may handle radio-frequency antenna signals in one or more communications bands. The radio-frequency antenna signals may pass through the slots in the antenna window.

### BACKGROUND

This invention relates to antennas, and more particularly, to windows formed from slots that allow antennas to operate from within electronic devices such as portable electronic devices.

Due in part to their mobile nature, portable electronic devices are often provided with wireless communications capabilities. Portable electronic devices may use wireless communications to communicate with wireless base stations. For example, cellular telephones may communicate using cellular telephone bands at 850 MHz, 900 MHz, 1800 MHz, and 1900 MHz (e.g., the main Global System for Mobile Communications or GSM cellular telephone bands). Portable electronic devices may also use other types of communications links. For example, portable electronic devices may communicate using the Wi-Fi® (IEEE 802.11) bands at 2.4 GHz and 5.0 GHz and the Bluetooth® band at 2.4 GHz. Communications are also possible in data service bands such as the 3G data communications band at 2100 MHz band (commonly referred to as UMTS or Universal Mobile Telecommunications System).

To satisfy consumer demand for small form factor wireless devices, manufacturers are continually striving to reduce the size of components that are used in these devices. For example, manufacturers have made attempts to miniaturize the antennas used in portable electronic devices.

A typical antenna may be fabricated by patterning a metal layer on a circuit board substrate or may be formed from a sheet of thin metal using a foil stamping process. These techniques can be used to produce antennas that fit within the tight confines of a compact portable device such as a handheld electronic device. With conventional portable electronic devices, however, design compromises are made to accommodate compact antennas. These design compromises may include, for example, compromises related to antenna efficiency and antenna bandwidth. Because many portable electronic devices and electronic devices have metal housings, conventional antenna arrangements also generally require the use of plastic antenna caps. These caps serve as dielectric windows in metal housings and allow antennas to be mounted internally, but can be unsightly and can introduce structural weaknesses.

It would therefore be desirable to be able to provide improved antenna structures for electronic devices such as portable electronic devices.

### SUMMARY

Wireless communications structures for computers or other electronic devices are provided. The wireless communications structures may include antennas and antenna window structures formed from slotted conductive surfaces.

The electronic devices may have housings in which electrical components are mounted. The housings may be used, for example, to house components such as processors, memory, and input-output devices. Wireless transceiver circuitry, antennas, and other electrical components may be contained within a device housing.

The housing of a device may be formed from metal, metal alloys, or other conductive materials. An antenna may be housed within the housing. To allow radio-frequency antenna signals to pass through the conductive housing, an antenna window may be formed in the conductive housing from one or more dielectric-filled slots. As an example, an antenna window may be formed in the metal housing of a computer using about ten parallel narrow slots. The slots, which may be filled with air or a solid dielectric such as epoxy, may be narrow enough that they are invisible to the naked eye or are at least unnoticeable under normal observation. For example, the slots may be tens of microns wide. The length of the slots may be selected to avoid blocking radio-frequency antenna signals at frequencies of interest.

Further features of the invention, its nature and various advantages will be more apparent from the accompanying drawings and the following detailed description of the preferred embodiments.

### BRIEF DESCRIPTION OF THE DRAWINGS

FIG. 1 is a perspective view of an illustrative electronic device such as a portable electronic device in accordance with an embodiment of the present invention.

FIG. 2 is a schematic diagram of an illustrative electronic device in accordance with an embodiment of the present invention.

FIG. 3 is a perspective view of an illustrative conductive housing portion that has an antenna window formed from slots in accordance with an embodiment of the present invention.

FIG. 4 is a cross-sectional side view of an illustrative electronic device having an antenna and an antenna window formed from housing slots in accordance with an embodiment of the present invention.

FIG. 5 is a perspective view of a portion of an electronic device in which a cavity antenna has been formed and in which an antenna window is being used to allow radio-frequency signals to pass to and from the antenna through a conductive device surface in accordance with an embodiment of the present invention.

FIG. 6 is a graph showing how an antenna such as an antenna of the type shown in FIG. 5 may be used to cover multiple communications bands in accordance with an embodiment of the present invention.

FIG. 7 is a perspective view of an antenna and an illustrative conductive surface such as a conductive housing wall in an electronic device in which an antenna window for the antenna has been formed using dielectric-filled slots in accordance with an embodiment of the present invention.

FIG. 8 is a perspective view of an illustrative inverted-F antenna that may be used in conjunction with a slot-based antenna window of the type shown in FIG. 7 in accordance with an embodiment of the present invention.

FIG. 9 is a perspective view of an illustrative slot antenna that may be used in conjunction with a slot-based antenna window of the type shown in FIG. 7 in accordance with an embodiment of the present invention.

FIG. 10 is a perspective view of an illustrative Vivaldi horn antenna that may be used in conjunction with a slot-based antenna window of the type shown in FIG. 7 in accordance with an embodiment of the present invention.

FIG. 11 is a top view of an illustrative slotted antenna window in which slots form zigzag shapes in accordance with an embodiment of the present invention.

### DETAILED DESCRIPTION

The present invention relates generally to electronic devices, and more particularly, to antennas and antenna windows for wireless electronic devices.

The wireless electronic devices may be any suitable electronic devices. As an example, the wireless electronic devices may be desktop computers or other computer equipment. The wireless electronic devices may also be portable electronic devices such as laptop computers, tablet computers, or small portable computers of the type that are sometimes referred to as ultraportables. Portable electronic devices may also be somewhat smaller devices. Examples of smaller portable electronic devices include wrist-watch devices, pendant devices, headphone and earpiece devices, and other wearable and miniature devices. With one suitable arrangement, the portable electronic devices may be handheld electronic devices.

Examples of portable and handheld electronic devices include cellular telephones, media players with wireless communications capabilities, handheld computers (also sometimes called personal digital assistants), remote controls, global positioning system (GPS) devices, and handheld gaming devices. The devices may also be hybrid devices that combine the functionality of multiple conventional devices. Examples of hybrid devices include a cellular telephone that includes media player functionality, a gaming device that includes a wireless communications capability, a cellular telephone that includes game and email functions, and a handheld device that receives email, supports mobile telephone calls, has music player functionality and supports web browsing. These are merely illustrative examples.

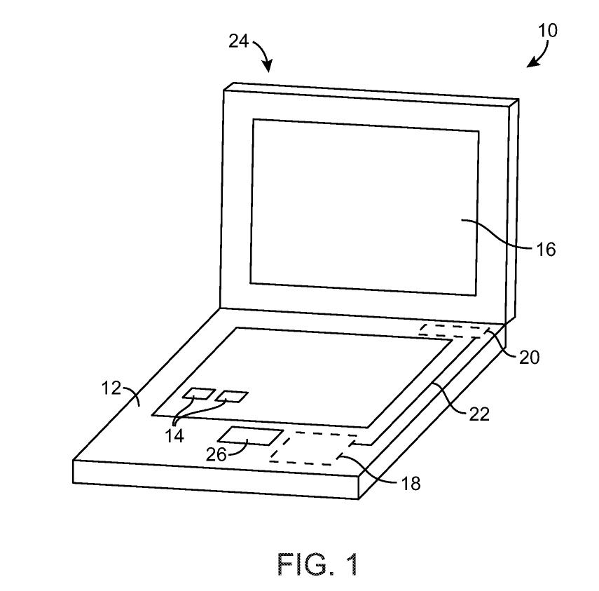

An illustrative electronic device such as a portable electronic device in accordance with an embodiment of the present invention is shown in FIG. 1. Device 10 may be any suitable electronic device. As an example, device 10 may be a laptop computer.

Device 10 may handle communications over one or more communications bands. For example, wireless communications circuitry in device 10 may be used to handle cellular telephone communications in one or more frequency bands and data communications in one or more communications bands. Typical data communications bands that may be handled by the wireless communications circuitry in device 10 include the 2.4 GHz band that is sometimes used for Wi-Fi® (IEEE 802.11) and Bluetooth® communications, the 5.0 GHz band that is sometimes used for Wi-Fi communications, the 1575 MHz Global Positioning System band, and 3G data bands (e.g., the UMTS band at 1920-2170). These bands may be covered by using single-band and multiband antennas. For example, cellular telephone communications can be handled using a multiband cellular telephone antenna and local area network data communications can be handled using a multiband wireless local area network antenna. As another example, device 10 may have a single multiband antenna for handling communications in two or more data bands (e.g., at 2.4 GHz and at 5.0 GHz).

Device 10 may have housing 12. Housing 12, which is sometimes referred to as a case, may be formed of any suitable materials including plastic, glass, ceramics, metal, other suitable materials, or a combination of these materials. In some situations, portions of housing 12 may be formed from a dielectric or other low-conductivity material, so as not to disturb the operation of conductive antenna elements that are located in proximity to housing 12.

In general, however, housing 12 will be partly or entirely formed from conductive materials such as metal. An illustrative metal housing material that may be used is anodized aluminum. Aluminum is relatively light in weight and, when anodized, has an attractive insulating and scratch-resistant surface. If desired, other metals can be used for the housing of device 10, such as stainless steel, magnesium, titanium, alloys of these metals and other metals, etc. In scenarios in which housing 12 is formed from conductive elements, one or more of the conductive elements may be used as part of the antenna in device 10. For example, metal portions of housing 12 and metal components in housing 12 may be shorted together to form a ground plane in device 10 or to expand a ground plane structure that is formed from a planar circuit structure such as a printed circuit board structure (e.g., a printed circuit board structure used in forming antenna structures for device 10).

Device 10 may have one or more buttons such as buttons 14. Buttons 14 may be formed on any suitable surface of device 10. In the example of FIG. 1, buttons 14 have been formed on the top surface of device 10. Buttons 14 may form a keyboard on a laptop computer (as an example).

If desired, device 10 may have a display such as display 16. Display 16 may be a liquid crystal diode (LCD) display, an organic light emitting diode (OLED) display, a plasma display, or any other suitable display. The outermost surface of display 16 may be formed from one or more plastic or glass layers. If desired, touch screen functionality may be integrated into display 16. Device 10 may also have a separate touch pad device such as touch pad 26. An advantage of integrating a touch screen into display 16 to make display 16 touch sensitive is that this type of arrangement can save space and reduce visual clutter. Buttons 14 may, if desired, be arranged adjacent to display 16. With this type of arrangement, the buttons may be aligned with on-screen options that are presented on display 16. A user may press a desired button to select a corresponding one of the displayed options.

Device 10 may have circuitry 18. Circuitry 18 may include storage, processing circuitry, and input-output components. Wireless transceiver circuitry in circuitry 18 may be used to transmit and receive radio-frequency (RF) signals. Transmission lines such as coaxial transmission lines and microstrip transmission lines may be used to convey radio-frequency signals between transceiver circuitry and antenna structures in device 10. As shown in FIG. 1, for example, transmission line 22 may be used to convey signals between antenna structure 20 and circuitry 18. Transmission line 22 may be, for example, a coaxial cable that is connected between an RF transceiver (sometimes called a radio) and an antenna. Antenna structures such as antenna structure 20 may be located adjacent to keys 14 as shown in FIG. 1 or may be located in other suitable locations (e.g., top cover surface 24 of housing 12).

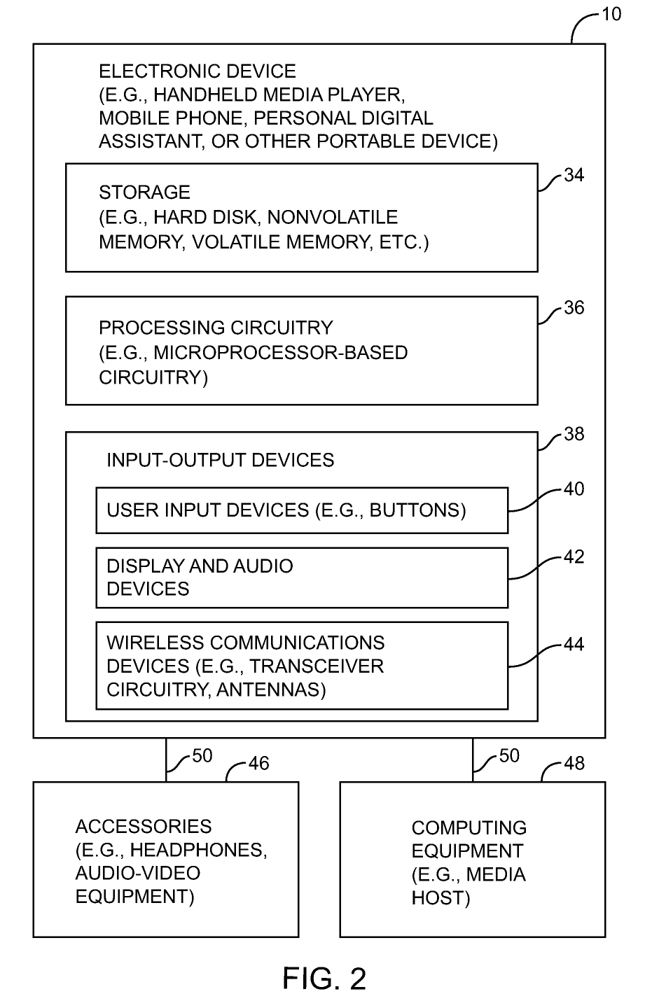

A schematic diagram of an embodiment of an illustrative electronic device such as a portable electronic device is shown in FIG. 2. Device 10 may be a desktop computer, a notebook computer, a mobile telephone, a mobile telephone with media player capabilities, a handheld computer, a remote control, a game player, a global positioning system (GPS) device, a combination of such devices, or any other wireless device such as a portable or handheld electronic device.

As shown in FIG. 2, device 10 may include storage 34. Storage 34 may include one or more different types of storage such as hard disk drive storage, nonvolatile memory (e.g., flash memory or other electrically-programmable-read-only memory), volatile memory (e.g., battery-based static or dynamic random-access-memory), etc.

Processing circuitry 36 may be used to control the operation of device 10. Processing circuitry 36 may be based on a processor such as a microprocessor and other suitable integrated circuits. With one suitable arrangement, processing circuitry 36 and storage 34 may be used to run software on device 10, such as internet browsing applications, voice-over-internet-protocol (VOIP) telephone call applications, email applications, media playback applications, operating system functions, etc. Processing circuitry 36 and storage 34 may be used in implementing suitable communications protocols. Communications protocols that may be implemented using processing circuitry 36 and storage 34 include internet protocols, wireless local area network protocols (e.g., IEEE 802.11 protocols—sometimes referred to as Wi-Fi®), protocols for other short-range wireless communications links such as the Bluetooth® protocol, protocols for handling 3G data services such as UMTS, cellular telephone communications protocols, etc.

Input-output devices 38 may be used to allow data to be supplied to device 10 and to allow data to be provided from device 10 to external devices. Display screen 16, keys 14, and touchpad 26 of FIG. 1 are examples of input-output devices 38.

Input-output devices 38 may include user input-output devices 40 such as buttons, touch screens, joysticks, click wheels, scrolling wheels, touch pads, key pads, keyboards, microphones, cameras, speakers, tone generators, vibrating elements, etc. A user can control the operation of device 10 by supplying commands through user input devices 40.

Display and audio devices 42 may include liquid-crystal display (LCD) screens or other screens, light-emitting diodes (LEDs), and other components that present visual information and status data. Display and audio devices 42 may also include audio equipment such as speakers and other devices for creating sound. Display and audio devices 42 may contain audio-video interface equipment such as jacks and other connectors for external headphones and monitors.

Wireless communications devices 44 may include communications circuitry such as radio-frequency (RF) transceiver circuitry formed from one or more integrated circuits, power amplifier circuitry, passive RF components, one or more antennas (e.g., antenna structures such as antenna structure 20 of FIG. 1), and other circuitry for handling RF wireless signals. Wireless signals can also be sent using light (e.g., using infrared communications).

Device 10 can communicate with external devices such as accessories 46 and computing equipment 48, as shown by paths 50. Paths 50 may include wired and wireless paths. Accessories 46 may include headphones (e.g., a wireless cellular headset or audio headphones) and audio-video equipment (e.g., wireless speakers, a game controller, or other equipment that receives and plays audio and video content).

Computing equipment 48 may be any suitable computer. With one suitable arrangement, computing equipment 48 is a computer that has an associated wireless access point or an internal or external wireless card that establishes a wireless connection with device 10. The computer may be a server (e.g., an internet server), a local area network computer with or without internet access, a user's own personal computer, a peer device (e.g., another portable electronic device 10), or any other suitable computing equipment.

The antenna structures and wireless communications devices of device 10 may support communications over any suitable wireless communications bands. For example, wireless communications devices 44 may be used to cover communications frequency bands such as the cellular telephone bands at 850 MHz, 900 MHz, 1800 MHz, and 1900 MHz, data service bands such as the 3G data communications band at 2100 MHz band (commonly referred to as UMTS or Universal Mobile Telecommunications System), Wi-Fi® (IEEE 802.11) bands (also sometimes referred to as wireless local area network or WLAN bands), the Bluetooth® band at 2.4 GHz, and the global positioning system (GPS) band at 1575 MHz. Wi-Fi bands that may be supported include the 2.4 GHz band and the 5.0 GHz bands. The 2.4 GHz Wi-Fi band extends from 2.412 to 2.484 GHz. Commonly-used channels in the 5.0 GHz Wi-Fi band extend from 5.15-5.85 GHz, so the 5.0 GHz band is sometimes referred to by the 5.4 GHz approximate center frequency for this range (i.e., these communications frequencies are sometimes referred to as making up a 5.4 GHz communications band). Device 10 can cover these communications bands and/or other suitable communications bands with proper configuration of the antenna structures in wireless communications circuitry 44.

Antennas do not function well when enclosed within conventional conductive housings. This is because the conductive housing walls of a conventional device serve as electromagnetic shielding that prevents radio-frequency antenna signals from being transmitted or received by internal antennas. To overcome this problem, some conventional device designs resort to the use of external antennas. However, external antennas can be unsightly and can be more prone to accidental breakage than internal antennas.

As an alternative to external antenna arrangements, some conventional devices use internal antennas. To accommodate internal antennas in conventional electronic devices with conductive housing walls, such devices are often provided with dielectric antenna windows in their conductive housing walls. An example of a conventional dielectric window is a plastic antenna cap. When an internal antenna is located directly beneath a plastic antenna cap, the internal antenna can function properly, even though it is housed within an electronic device that is otherwise enclosed within a conductive case. This type of arrangement may be used to supply electronic devices that have conductive housings with internal antennas. However, the plastic antenna cap material typically does not blend well with metal housings. Plastic antenna caps are therefore often unsightly. Although it may be possible to locate a plastic antenna cap in an inconspicuous location such as on the rear of a device housing, this type of approach is not always satisfactory.

In accordance with embodiments of the present invention, antenna windows are formed from dielectric-filled openings in a conductive surface. The dielectric-filled openings may have dimensions that are small enough to make the openings invisible or at least unnoticeable to the naked eye under normal observation. The dielectric-filled openings for the antenna windows may be formed in conductive housing walls, so there is no need to use unsightly plastic antenna caps in electronic devices with conductive housings and internal antennas.

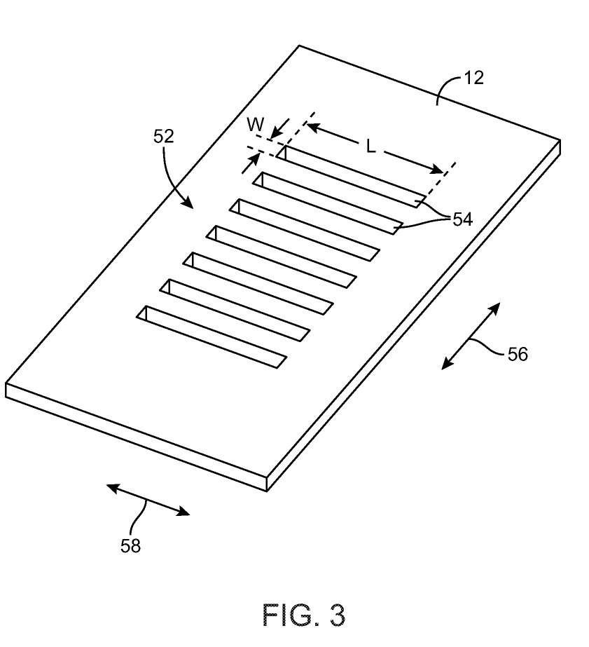

A perspective view of a portion of a conductive exterior surface in an electronic device in which an antenna window has been formed is shown in FIG. 3. As shown in FIG. 3, antenna window 52 may be formed from openings 54 in conductive surface 12.

Conductive surface 12 may be any conductive external surface associated with electronic equipment such as electronic device 10 (e.g., a handle surface, a surface associated with a base or other support structure, etc.). In a typical scenario, conductive surface 12 is a substantially planar conductive housing surface. Such conductive structures are sometimes referred to as device housings, devices cases, housing or case walls, housing or case surfaces, etc.

Openings 54 may be filled with a dielectric such as air or a solid dielectric such as plastic or epoxy. An advantage of filling openings 54 with a solid dielectric material is that this may help prevent intrusion of dust, liquids, or other foreign matter into the interior of device 10.

Openings 54, which are sometimes referred to as slots or microslots, may have any suitable shape (e.g., shapes with curved sides, shapes with bends, circular or oval shapes, non-rectangular polygonal shapes, combinations of these shapes, etc.). In a typical arrangement, which is described herein as an example, slots 54 may be substantially rectangular in shape and may have narrower dimensions (i.e., widths W measured parallel to lateral dimension 56) and longer dimensions (e.g., lengths L measured parallel to longitudinal dimension 58). This is merely illustrative. Slots 54 may have any suitable non-rectangular shapes (e.g., shapes with non-perpendicular edges, shapes with curved edges, shapes with bends, etc.). The use of rectangular slot configurations is only described herein as an example.

Whether straight, curved, or having shapes with bends, the widths (i.e., the narrowest lateral dimensions) of slots 54 are generally much less than their lengths. For example, the widths of slots 54 may be on the order of microns, tens of microns, or hundreds of microns (e.g., 5-200 microns, 10-30 microns, less than 100 microns, less than 50 microns, less than 30 microns, etc.), whereas the lengths of slots 54 may be on the order of millimeters or centimeters (e.g., 10 mm or more). With one suitable arrangement, the lengths of slots 54 may be selected so that the slots are longer than a half of a wavelength at a desired antenna operating frequency (e.g., the lowest frequency associated with the communications bands being used). This helps to prevent slots 54 from resonating at the antenna operating frequency and thereby allows slots 54 to form a structure for antenna window 52 that is transparent to radio-frequency antenna signals at the operating frequencies of the antenna. If desired, the length of slots 54 may be selected so that the frequency response of the slots allows the slots to serve as a tuning element (e.g., a length-dependent tuning element in the lower frequency band).

Slots 54 that have particularly small widths (e.g., tens of microns) are generally invisible to the naked eye under normal observation. Slots 54 that have somewhat larger widths (e.g., hundreds of microns) may be barely visible, but will generally be unnoticeable under normal observation. For example, on a shiny metallic surface of a laptop computer, window 52 may be barely visible in the form of a slight change in the sheen of the surface when viewed from an oblique angle. The use of narrow slots 54 to form antenna window 52 therefore allows window 52 to be located in prominent device locations without becoming obtrusive. For example, antenna window 52 may be formed on normally exposed portions of housing 12. Examples of normally exposed housing portions include the exterior surfaces of a laptop computer or other device 10, surfaces of a laptop computer such as the housing surface adjacent to the keyboard or display (e.g., when the cover of a laptop computer has been opened for use), or housing sidewalls.

In the example of FIG. 3, there are seven slots 54 in antenna window 52. This is merely illustrative. Antenna window 52 may have any suitable number of slots. For example, window 52 may have about 7-13 slots, 4-20 slots, more than 5 slots, more than 10 slots, more than 15 slots, etc. If desired, antenna window 52 may have smaller numbers of slots (e.g., 1-3 slots). In general, however, larger numbers of slots are helpful in increasing the transparency of the antenna window to radio-frequency antenna signals and may therefore be preferred.

Slots 54 may be spaced apart by any suitable amount. As an example, there may be about 1 to 1.5 mm, 0.5 to 2 mm, or 0.25 to 3 mm of lateral separation between adjacent pairs of slots. These are merely illustrative examples. Slots 54 may be separated by any suitable distance (e.g., less than 0.5 mm, less than 1 mm, less than 2 mm, more than 2 mm, etc.). An advantage of providing adequate separation (e.g., about 1 mm) between adjacent slots is that this helps the antenna window structure from becoming fragile due to an excessive density of slots.

The spacings between the slots in a given antenna window need not be uniform. For example, some slots may be spaced apart by 1 mm lateral separations and other slots may be spaced apart by 1.5 mm lateral separations. In other suitable configurations, each pair of adjacent slots may be separated by a different distance. Combinations of these slot spacing schemes may also be used.

If desired, the slots in antenna window 52 may have non-uniform lengths L. For example, each slot 54 may have a different length. Alternatively, some slots may have the same length and other slots may have different lengths. Slots 54 may also have different widths. The use of different combinations of slot widths, slot lengths, slot spacings, and slots shapes may be helpful when forming an antenna window around an obstacle in a given electronic device conductive surface or when forming a particular pattern of slots. Slot widths in antenna window 52 may, if desired, be made large enough to form a visible pattern on the surface of device 12 (e.g., to form a logo or other desirable antenna window pattern). In general, however, it is advantageous to ensure that the slots in window 52 are narrow enough to be invisible or unnoticeable to the naked eye under normal observation.

Slots 54 may be formed using any suitable technique. For example, slots may be machined in metal walls or other conductive wall structures in housing 12 using laser cutting, plasma arc cutting, micromachining (e.g., using grinding tools), or other suitable techniques.

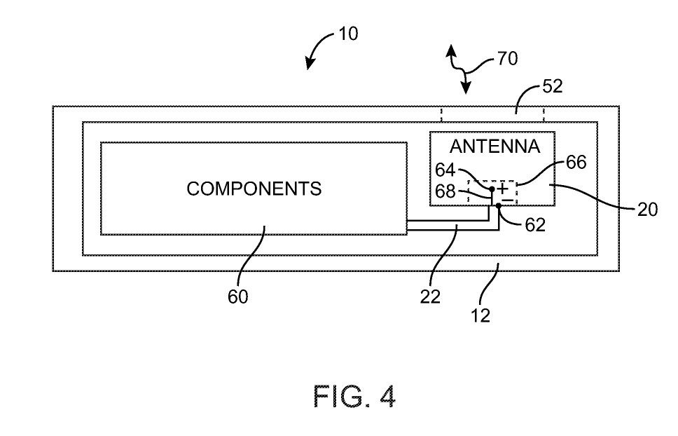

A cross-sectional side view of an illustrative electronic device is shown in FIG. 4. As shown in the example of FIG. 4, device 10 may include internal electronic components 60. Components 60 may include circuitry of the type shown in FIG. 2 (e.g., storage 34, processing circuitry 36, and input output devices 38). As an example, components 60 may include radio-frequency transceiver circuitry. The radio-frequency transceiver circuitry may include one or more radio-frequency transceivers (sometimes referred to as radios). Radio-frequency transceiver circuitry in components 60 may be coupled to antenna such as antenna 20 of FIG. 4 using a transmission line such as transmission line 22. Transmission line 22 may be formed using a coaxial cable, a microstrip transmission line, or any other paths that support the transmission of radio-frequency signals for antenna 20.

Transmission line 22 may be used to convey radio-frequency signals between antenna 20 and radio-frequency transceiver circuitry in components 60. The transceiver circuitry may include one or more transceivers for handling communications in one or more discrete communications bands. For example, transceiver circuitry in components 60 may be used to handle communications in 2.4 GHz and 5.0 GHz communications bands. Transceiver circuitry in components 60 may include a diplexer or other suitable circuitry for combining the signals associated with multiple individual transceivers. For example, components 60 may include a 2.4 GHz transceiver, a 5.0 GHz transceiver, and a diplexer that allows the 2.4 GHz and 5.0 GHz transceivers to be connected to a common transmission line 22.

Transmission line 22 may be coupled to antenna 20 at feed terminals such as feed terminals 62 and 64. Feed terminal 62 may be referred to as a ground or negative feed terminal and may be shorted to the outer (ground) conductor of transmission line 22. Feed terminal 64 may be referred to as the positive antenna terminal. Transmission line center conductor 68 may be used to connect transmission line 22 to positive feed terminal 64. If desired, other types of antenna coupling arrangements may be used (e.g., based on near-field coupling, using impedance matching networks, etc.).

As shown schematically by dashed line 66 in FIG. 4, the feed arrangement for antenna 20 may include a matching network. Matching network 66 may include a balun (to match an unbalanced transmission line to a balanced antenna) and/or an impedance transformer (to help match the impedance of the transmission line to the impedance of the antenna).

Antenna 20 may be used to transmit and receive radio-frequency signals 70. Antenna 20 is preferably located adjacent to antenna window 52, as shown in FIG. 4. This allows radio-frequency signals 70 to be transmitted through antenna window 52 and to be received through antenna window 52. It is not generally necessary for antenna 20 to be located immediately adjacent to window 52 (i.e., in direct contact with window 52), provided that the separation between antenna 20 and window 52 is not too great. For example, antenna 20 may be placed within a few millimeters or other suitable distance of antenna window 52. In the example of FIG. 4, antenna 20 is located directly beneath window 52.

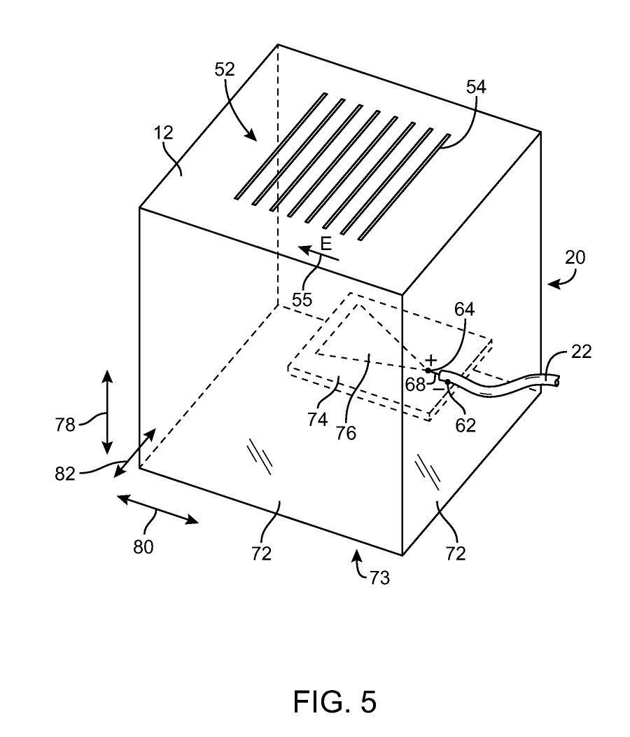

Antennas such as antenna 20 may be formed using any suitable antenna design. For example, antennas such as antenna 20 may be aperture type antennas. An example of an illustrative antenna 20 that has been formed from a conductive cavity (i.e., a cavity antenna) is shown in FIG. 5. As shown in FIG. 5, a generally cube-shaped cavity for antenna 20 may be formed from a conductive bottom wall 73, conductive sidewalls 72, and conductive surface 12. Conductive surface 12 may be, for example, a conductive housing wall of device 10. The conductive materials in the walls of the cavity may be, for example, metals or metal alloys, such as copper, aluminum, stainless steel, gold, etc.

Antenna 20 of FIG. 5 may be fed by coaxial transmission line 22. The outer ground conductor of cable 22 may be connected to a cavity wall at antenna ground terminal 62. Center conductor 68 of cable 22 may be connected to triangular probe feed element 76 at positive antenna feed terminal 64. Triangular probe feed element 76 may be formed from a conductive triangular-shaped trace on a printed circuit board or other suitable dielectric substrate 74. Element 76 may have any suitable shape (e.g., a shape with straight sides, a shape with curved sides, a shape with curved and straight sides, etc.). Element 76 forms a probe feed that conveys antenna signals into and out of the chamber formed by walls 72, wall 73, and conductive surface 12. The polarization of the antenna signals is preferably such that the electric field E of the antenna signals is oriented perpendicular to the longitudinal axes of slots 54, as shown by arrow 55 in FIG. 5.

The cavity of antenna 20 of FIG. 5 may have any suitable lateral dimensions (measured in vertical dimension 78 and horizontal dimensions 80 and 82). With one suitable arrangement, the lateral dimensions of the cavity may be selected to be greater than a half of a wavelength at the lowest antenna signal frequency of interest to avoid cutting off antenna modes at that frequency. As an example, consider a cavity antenna that is to cover the 2.4 GHz communications band (e.g., for IEEE 802.11 communications). In this type of situation, the dimensions of the antenna cavity may be selected to be greater than a half of a wavelength at 2.4 GHz. This prevents the cavity from cutting off the 2.4 GHz antenna modes, as might happen if the dimensions of the cavity were significantly less than a half of a wavelength at 2.4 GHz.

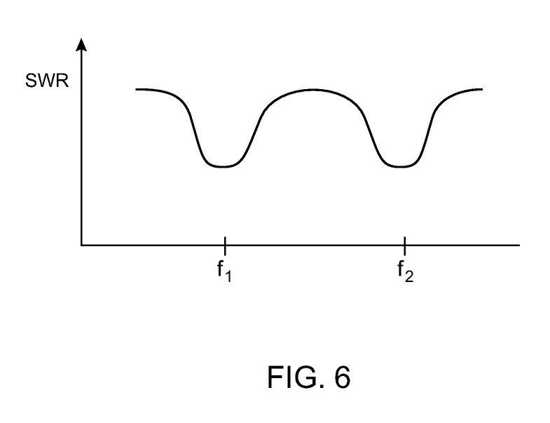

An illustrative performance graph for an antenna such as antenna 20 of FIG. 5 is shown in FIG. 6. As shown in FIG. 6, a cavity antenna such as antenna 20 of FIG. 5 may cover multiple communications bands of interest. In particular, antenna 20 of FIG. 5 may cover a first communications band at frequency f1 and a second communications band at frequency f2. The first band may be (for example) the 2.4 GHz IEEE 802.11 band and the second band may be (for example) the 5.0 GHz IEEE 802.11 band (sometimes referred to by its approximate center frequency of 5.4 GHz). The response of antenna 20 at frequency f2 corresponds to a second order resonance. In this example, higher order resonances are not of interest, but in general, a cavity antenna having a slotted antenna window such as antenna 20 of FIG. 5 may have any suitable number of higher order resonances.

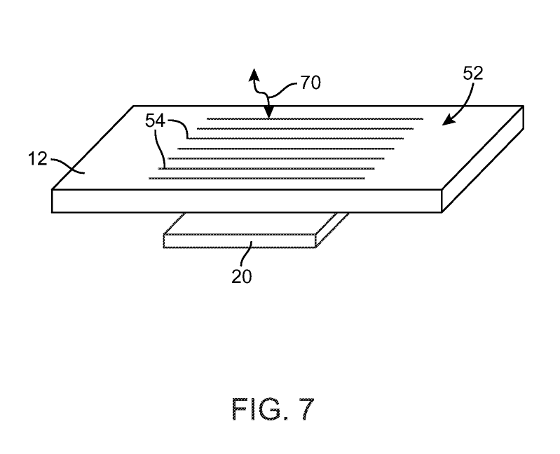

If desired, other (non-cavity-type) antennas may be used with a slotted antenna window. As shown in FIG. 7, when an antenna 20 is located in the vicinity of antenna window 52, radio-frequency antenna signals 70 may pass through window 52 (e.g., when antenna signals are received by antenna 20 and when antenna signals are transmitted by antenna 20). Window 52 may be formed in any suitable conductive surface associated with device 10 such as a conductive housing surface. Antennas such as antenna 20 of FIG. 7 may be formed using any suitable antenna design.

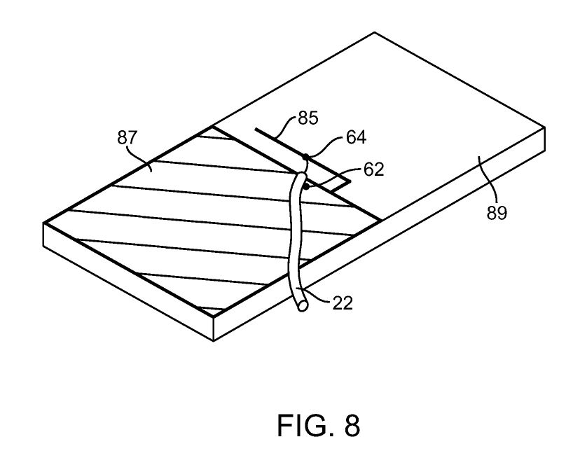

As an example, an antenna such as antenna 20 of FIG. 8 may serve as antenna 20 of FIG. 7. In the FIG. 8 example, antenna 20 is an inverted-F antenna that is fed using antenna terminals 62 and 64. Inverted-F antenna 20 of FIG. 8 may be formed from conductive traces on rigid or flexible printed circuit boards, may be formed from conductive foil (e.g., stamped metal foil), may be formed from portions of housing 12 or electrical components 60 (FIG. 4), may be formed from bent wires or other L-shaped conductive structures, or may be formed from any other suitable structures. In the illustrative arrangement of FIG. 8, inverted-F antenna 20 has an antenna resonating element 85 and ground plane 87 on dielectric support 89.

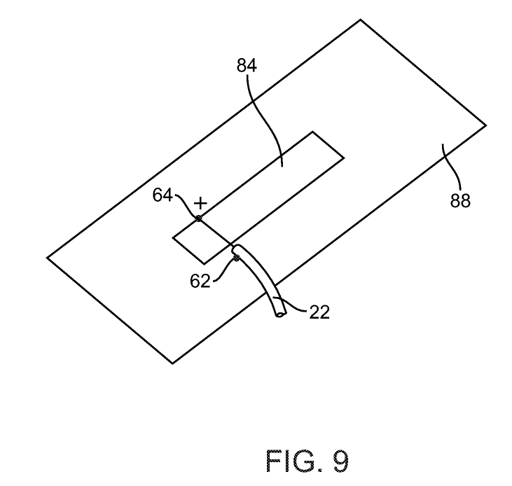

Another example of an antenna that may be used with slotted antenna window 52 is shown in FIG. 9. In the FIG. 9 configuration, antenna 20 is a slot antenna. Slot antenna 20 of FIG. 9 may be formed from ground plane 88 and opening (slot) 84. Slot 84 may be filled with air or a solid dielectric such as epoxy or plastic. Antenna 20 of FIG. 9 may be fed using any suitable arrangement (e.g., using a matching network such as matching network 66 of FIG. 4). As shown schematically in FIG. 9, antenna 20 may have antenna feed terminals 64 and 62 that are coupled to opposing sides of slot 84 (as an example). Slot antenna 20 may be oriented so that slot 84 is parallel to slots 52.

Ground plane 88 of antenna 20 of FIG. 9 may be formed from a portion of housing 12, a layer of conductor on a substrate such as a printed circuit board substrate, a layer of metal that is separate from substrates and that is separate from housing 12, conductive electrical components, other suitable conductive structures, or combinations of these structures.

Ground plane elements for antenna 20 such as ground plane element 88 of FIG. 9 and other conductive antenna structures may be mounted on substrates. Such substrates may be formed from a dielectric such as a rigid or flexible printed circuit material. An example of a rigid circuit board substrate is the dielectric sometimes referred to as FR4. An example of a flexible printed circuit board material is polyimide. Flexible printed circuits are sometimes referred to as flex circuits and may be mounted to dielectric support structures such as plastic supports.

Slot 84 in ground plane 88 may serve as an antenna resonating element for antenna 20 of FIG. 9. Suitable materials for forming antenna structures such as ground plane 88 include metals (e.g., copper, gold, etc.) and metal alloys. Slot 84 may be formed in any suitable shape. For example, Slot 84 may be formed in the shape of a rectangle, a polygon with more than or less than four sides, a shape with curved sides, a polygon with only straight sides, a shape with bends, a shape with a combination of straight sides, curved sides, and bends, etc.

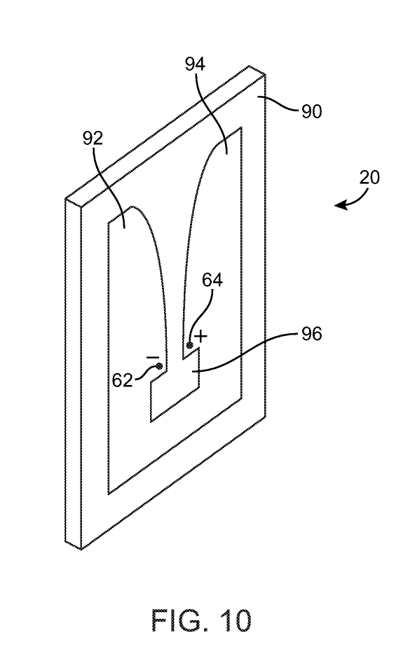

As shown in FIG. 10, antenna 20 may be formed using a Vivaldi horn antenna configuration. In this type of arrangement, antenna 20 may have a substrate 90. Substrate 90 may be, for example, a flexible or rigid printed circuit board substrate. Conductive regions 92 and 94 may form poles for antenna 20. Conductive regions 92 and 94 may be fed using antenna terminals 62 and 64. A matching network may be used when feeding antenna 20. The size and shape of gap region 96 may be adjusted to help with impedance matching. The plane of Vivaldi horn antenna 20 is preferably oriented to be perpendicular to window 52 and perpendicular to slots 54.

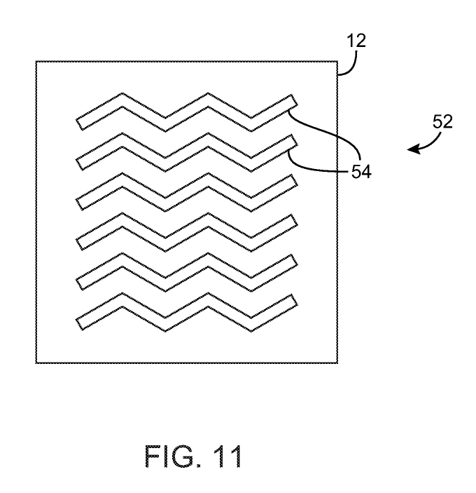

The examples of FIGS. 8, 9, and 10 are merely illustrative. In general, any suitable antennas may be used in conjunction with antenna window 52 if desired. Examples of other suitable antennas include aperture antennas, rectangular horn antennas, ridged rectangular horn antennas, etc. The slots in window 52 may also have a variety of different shapes. As shown in FIG. 11, for example, slots 54 in window 52 may have a zigzag shape.

The foregoing is merely illustrative of the principles of this invention and various modifications can be made by those skilled in the art without departing from the scope and spirit of the invention.

What is claimed is:

1. An antenna window through which antenna signals pass, comprising:
a conductive structure having portions configured to form at least one slot through which the antenna signals pass.

2. The antenna window defined in claim 1 wherein the portions are configured so that the slot has a width of less than 100 microns.

3. The antenna window defined in claim 2 wherein the conductive structure comprises a portion of an electronic device housing.

4. The antenna window defined in claim 3 wherein the portions are configured to form a plurality of slots through which the antenna signals pass and wherein each of the plurality of slots has a width of less than 100 microns.

5. The antenna window defined in claim 3 wherein the portions are configured to form three to seven slots through which the antenna signals pass and wherein each of the slots has a width of less than 100 microns.

6. The antenna window defined in claim 2 wherein the conductive structure comprises a portion of a portable electronic device housing.

7. The antenna window defined in claim 2 wherein the conductive structure comprises a conductive exterior housing wall in a computer.

8. The antenna window defined in claim 1 further comprising a solid dielectric that fills the slot.

9. An electronic device comprising:
transceiver circuitry;
a transmission line coupled to the transceiver circuitry;
a conductive case in which the transceiver circuitry and the transmission line are housed, wherein the conductive case has an antenna window formed from a plurality of slots; and
an antenna that is coupled to the transmission line and that handles radio-frequency antenna signals that pass through the antenna window.

10. The electronic device defined in claim 9 wherein the conductive case comprises a portable electronic device housing wall in which the plurality of slots are formed.

11. The electronic device defined in claim 9 wherein the slots comprise slots that have widths of less than 100 microns.

12. The electronic device defined in claim 9 further comprising a solid dielectric material that fills the slots.

13. The electronic device defined in claim 9 wherein the electronic device comprises a portable electronic device and wherein the antenna comprises an inverted-F antenna.

14. The electronic device defined in claim 9 wherein the electronic device comprises a portable electronic device and wherein the antenna comprises a horn antenna.

15. The electronic device defined in claim 9 wherein the electronic device comprises a portable electronic device and wherein the antenna comprises a slot antenna.

16. The electronic device defined in claim 9 wherein the electronic device comprises a portable electronic device, wherein the antenna comprises a cavity antenna formed from a cavity having conductive walls, and wherein the conductive case forms at least one of the conductive walls of the cavity.

17. The electronic device defined in claim 9 wherein the antenna is configured to operate in communications bands at 2.4 GHz and 5.0 GHz.

18. The electronic device defined in claim 9 further comprising a solid dielectric that fills the slots.

19. Wireless communications structures in an electronic device that has a conductive device housing, comprising:
an antenna window formed from a plurality of slots formed in the conductive device housing; and
an antenna that handles radio-frequency antenna signals, wherein the antenna is contained within the conductive device housing of the electronic device and wherein the antenna signals pass through the plurality of slots in the antenna window.

20. The wireless communications structures defined in claim 19 wherein the plurality of slots each have a width of less than 50 microns and a length of at least 10 mm.

21. The wireless communications structures defined in claim 20 further comprising a solid dielectric that fills the slots.

22. The wireless communications structures defined in claim 20 wherein the electronic device comprises a computer, wherein the conductive device housing in which the plurality of slots for the antenna window are formed comprises a metal case for the computer, and wherein at least one of the slots comprises a bend.
